(19) United States
(12) Patent Application Publication
(10) Pub. No.: US 2026/0243191 A1
(43) Pub. Date: Aug. 20, 2026

(54) Prechamber Ignition Means for an Internal Combustion Engine and Engine Having Same

(71) Applicant: Bayerische Motoren Werke Aktiengesellschaft, Muenchen (DE)

(72) Inventors: Erik Schaefer, Muenchen (DE); Juergen Knupe, Dachau (DE); Daniel Taterra, Muenchen (DE); Alexander Koeck, Gronsdorf, Haar (DE)

(21) Appl. No.: 19/160,818

(22) PCT Filed: Feb. 13, 2024
(86) PCT No.: PCT/EP2024/053542

§ 371 Date: Aug. 28, 2025

(30) Foreign Application Priority Data
Mar. 9, 2023 (DE) 10 2023 105 825.8

(51) Int. Cl. F02B 19/12; F02B 19/16; H01T 13/32

(52) U.S. Cl. CPC F02B 19/12; F02B 19/16; H01T 13/32

(57) ABSTRACT

A prechamber ignition apparatus for an internal combustion engine includes a prechamber and a spark plug. The prechamber has a plurality of overflow openings via which the prechamber can be fluidically connected to a combustion chamber of the internal combustion engine. At least part of a mixture comprising fuel and air can be introduced into the prechamber from the combustion chamber. The spark plug has an ignition electrode by which at least one ignition spark can be produced in the prechamber between the ignition electrode and a corresponding ground electrode in order to ignite a part which is introduced into the prechamber via the overflow openings. The ground electrode and the spark plug having the ignition electrode are formed as structurally separated components.

The present application is the U.S. national phase of PCT Application PCT/EP2024/053542 filed on Feb. 13, 2024, which claims priority of German patent application No. 10 2023 105 825.8.0 filed on Mar. 9, 2023, the entire contents of which are incorporated herein by reference.

### TECHNICAL FIELD

The disclosure relates to a prechamber ignition means for an internal combustion engine, in particular of a motor vehicle. Furthermore, the disclosure relates to an internal combustion engine having at least one such prechamber ignition means.

### BACKGROUND

A prechamber spark plug can be taken as known from DE 10 2016 208 992 A1, having a housing, an ignition electrode and a ground electrode. U.S. Pat. No. 8,839,762 B1 discloses a system for igniting a mixture in an internal combustion engine. DE 10 2018 007 093 A1 discloses a prechamber spark plug for a combustion chamber of an internal combustion engine. In addition, DE 10:2020 106 397 A1 discloses an externally ignited reciprocating piston internal combustion engine having a prechamber ignition system.

There is a need, however, for a prechamber ignition means for an internal combustion engine, in particular of a motor vehicle, and an internal combustion engine, that avoids unfavorable combustion.

### SUMMARY

The above-described need, as well as others, are addressed by at least some embodiments of described herein.

A first aspect relates to a prechamber ignition means, also designated as a prechamber ignition system, for an internal combustion engine, in particular of a motor vehicle. This means that, in its completely produced state, the internal combustion engine has the prechamber ignition means. In addition, for example, provision is made for the aforementioned motor vehicle, also designated simply as a vehicle and for example as an automobile, in particular designed as a passenger car, to have the internal combustion engine and thus the prechamber ignition means and to be drivable by means of the internal combustion engine.

In some embodiments, the internal combustion engine is designed as a reciprocating piston machine, consequently as a reciprocating piston motor. The internal combustion engine is also designated as an internal combustion motor or motor. The prechamber ignition means has a prechamber and a plurality of overflow openings which, in particular, are formed as passage openings. Via the overflow openings, the prechamber is or can be connected fluidically to a combustion chamber of the internal combustion engine, also designated as a main combustion chamber. Via the overflow openings, at least some of a fuel-air mixture, also designated simply as a mixture, which in particular is or can be initially accommodated in the main combustion chamber can be introduced into the prechamber from the combustion chamber, the mixture comprising an in particular liquid fuel and air.

If appropriate, the mixture can comprise at least one further constituent such as, for example, recycled exhaust gas. This means that in its completely produced state the internal combustion engine has the combustion chamber and the prechamber ignition means assigned to the combustion chamber, of which the prechamber is connected fluidically to the combustion chamber via the overflow openings and, for example, is otherwise separated fluidically from the combustion chamber. In other words, provision is preferably made for the overflow openings to be or to form the single fluidic connections between the main combustion chamber and the prechamber. The overflow openings open into the prechamber on one side, in particular at one end. On the other side, in particular at the other end, the overflow openings open into the surroundings of the prechamber means. In the completely produced state of the internal combustion engine, the surroundings are the main combustion chamber so that, in the completely produced state of the internal combustion engine, the overflow openings open into the combustion chamber (main combustion chamber) on the other side, in particular at the other end, as a result of which, in the completely produced state of the internal combustion engine, the prechamber is fluidically connected to the combustion chamber via the overflow openings and is preferably otherwise separated fluidically from the combustion chamber.

The prechamber and thus the prechamber ignition means are in particular used to carry out prechamber ignition, in particular in fired operation of the internal combustion engine and more particularly within a respective working cycle of the internal combustion engine. In particular, provision is made for the prechamber to be completely fluidically separated from the combustion chamber with the exception of respective fluidic connections between the prechamber and the combustion chamber that are formed by the respective overflow openings.

In the completely produced state of the internal combustion engine, the combustion chamber is, for example, partly delimited by a piston and, for example, partly by a cylinder, in which the piston can be accommodated so as to be movable, in particular translationally. For example, in particular within the respective working cycle of the internal combustion engine, the aforementioned mixture is formed in the combustion chamber and/or the mixture is introduced into the combustion chamber so that, in particular within the respective working cycle of the internal combustion engine, the mixture is initially accommodated in the combustion chamber. At least the aforementioned part of the mixture flows out of the combustion chamber (main combustion chamber) through the overflow openings, in particular when the piston moves in the direction of its top dead center or is at its top dead center, and thus via the overflow openings into the prechamber, so that, in particular within the respective working cycle, at least the part of the mixture from the main combustion chamber is introduced into the prechamber of the overflow openings.

The part of the mixture flowing through the overflow openings and, as a result, out of the combustion chamber into the prechamber via the overflow openings, is also designated as a first part of the mixture. In particular, it is conceivable that the piston, in particular on its way in the direction of its top dead center or at its top dead center, conveys at least the first part of the mixture out of the main combustion chamber through the overflow openings and, as a result, into the prechamber, as a result of which at least the first part of the mixture is introduced into the prechamber. It is in particular conceivable that a second part of the mixture remains in the main combustion chamber and thus in particular outside the prechamber.

The prechamber ignition means additionally has a spark plug, also designated a spark element, by means of which at least one ignition spark for igniting the first part introduced into the prechamber via the overflow openings can be generated in the prechamber and in particular within the respective working cycle. If, previously or in the following, mention is made of the part, this is to be understood as the first part if not otherwise specified. Thus, for example, particularly within the respective working cycle, the mixture flowing into the prechamber or introduced into the prechamber, which means the first part, is ignited, in particular as a result of the fact that the ignition spark is produced in the prechamber by means of the spark plug, in particular within the respective working cycle. The spark plug has in particular exactly one ignition electrode, which is also designated as a central electrode or can be formed as a central electrode. By means of the ignition electrode, the at least one or exactly one ignition spark for igniting the part of the mixture introduced into the prechamber via the overflow openings can be generated between the ignition electrode and a corresponding ground electrode. Provision the prechamber ignition means to have the ground electrode as a single ground electrode for producing the ignition spark. Thus, provision can be made for the prechamber ignition means to have at least or preferably exactly two electrodes, namely the ignition electrode and the ground electrode, between which the at least or exactly one ignition spark can be produced, in particular within the respective working cycle. By means of the ignition spark, the mixture flowing into the prechamber and thus accommodated in the prechamber, consequently the first part, is ignited and burned as a result. The mixture ignited in the prechamber and consequently burning then flows out of the prechamber through the overflow openings and, via the overflow openings, back into the main combustion chamber, for example in the form of burning flares or jets, which flow through the overflow openings. Since the burning mixture from the prechamber flows through the overflow openings and thus, via the overflow openings, out of the prechamber into the main combustion chamber, the rest of the mixture that has remained in the combustion chamber, consequently the aforementioned second part, is ignited and then burned. In this way, for example, the piston is driven and as a result moved in the direction of its bottom dead center or to its bottom dead center.

In order then to avoid unfavorable, undesired ignition and combustion of the mixture and thus to be able to ensure advantageous, in particular fired, operation of the internal combustion engine, at least one embodiment described herein provides for the ground electrode and the spark plug having the ignition electrode to be designed as structurally separated components. Provision can be made for the spark plug intrinsically, i.e. considered on its own, to have the ignition electrode, but to be free of a ground electrode corresponding to the ignition electrode. The feature that the spark plug and the ground electrode are designed as structurally separated components is to be understood in particular as the following: if, previously and in the following, mention is made of the components, then this is understood to be the spark plug and the ground electrode, if not otherwise specified, so that, for example, the spark plug is a first of the components and the ground electrode is a second of the components.

In the completely produced state of the internal combustion engine having the prechamber ignition means, the first component and the second component, consequently the spark plug and the ground electrode, are mounted, for example, on a third component of the internal combustion engine, in particular in such a way that the first component and the second component are fastened to the third component. For example, the first component and the second component are mounted on or fastened to the third component in such a way that both relative movements between the first component and the third component and relative movements between the second component and the third component and also relative movements between the first component and the second component are suppressed. For example, the third component is a cylinder head of the internal combustion engine. For example, the cylinder head forms a combustion chamber roof assigned to the combustion chamber, which partly delimits the combustion chamber. The piston is movable, for example translationally, in the cylinder and relative to the combustion chamber.

Since the spark plug and the ground electrode are now formed as structurally separated components, the spark plug can be removed from the third component, which means detached and moved away from the third component, specifically independently of the second component, which means while the second component remains mounted on the third component, particularly in such a way that relative movements between the third component and the second component are suppressed. Furthermore, it is for example possible that, in particular in a method for producing the internal combustion engine, the second component is firstly mounted on, in particular fastened to, the third component independently of the first component, in particular in such a way that relative movements between the second component and the third component are suppressed, while the first component is not (yet) mounted on the third component, consequently is still separated from and at a distance from the third component. The first component can, for example, be mounted on, in particular fastened to, the third component only after the second component has been mounted completely on the third component, in particular in such a way that relative movements between the first component and the third component are suppressed.

Once more expressed in other words, the ground electrode is not a constituent part of the spark plug, so that mounting the ground electrode on the third component is not or does not have to be involved in the mounting of the spark plug on the third component and/or so that mounting of the spark plug on the third component is not or does not have to be involved in the mounting of the ground electrode on the third component and/or that removal of the spark plug from the third component is not or does not have to be involved in the removal of the ground electrode from the third component, consequently so that the spark plug can be removed from the third component without removal of the ground electrode from the third component being involved, i.e. while the ground electrode remains mounted on the third component. As a result of this structural separation of the spark plug and the ground electrode, excessively high heating of the ground electrode can be avoided, in particular during the fired operation of the internal combustion engine, so that unfavorable, undesired ignition and/or combustion of the mixture can be avoided.

At least some embodiments are based on the following findings and considerations. Since, in particular within combustion chamber flows through the overflow openings and, as a result, flows into the prechamber via the overflow openings, in particular is transported into the prechamber or conveyed into the prechamber via the overflow openings by means of the piston, the prechamber is a so-called passive prechamber. In order to be able to implement a particularly high, in particular specific, output of the internal combustion engine, for example designed as a diesel engine, a particularly large volume of the prechamber is desirable so that, for example, the volume of the prechamber represents at least 0.2% of the stroke volume of the internal combustion engine. Since the prechamber of the prechamber ignition means: a passive prechamber, the prechamber is a prechamber which is in particular flushed with the mixture, also designated as combustion gas, only on the combustion chamber side.

Such a passive prechamber can lead to advantageously fast combustion in the main combustion chamber, in particular in diesel engines. This takes place because of the ignition of the mixture within the prechamber, also designated as pre-ignition, and by means of the flares, also designated as flare jets, which flow through the overflow openings at high speed and thus flow out of the prechamber into the combustion chamber via the overflow openings and produce multiple combustion locations in the combustion chamber. As compared with conventional solutions, the combustion in the main combustion chamber can take place more than twice as quickly. A need for preignition decreases drastically as a result.

Therefore, even without using a sub-stoichiometric combustion air ratio (enrichment), high power densities can be achieved. In order thus to keep the combustion period advantageously low and in particular to be able to reduce it to such an extent that enrichment can be avoided, in particular in internal combustion engines designed as diesel engines with high power densities, large-volume prechambers such as, for example, the prechamber of the prechamber ignition means can be used. However, one-piece spark plugs, also designated prechamber spark plugs or else conventional spark plugs in conjunction with separate prechambers, in particular at high prechamber volumes, tend to pre-ignition or to glow ignition as a result of excessively high temperatures of components of the prechamber spark plug or the conventional spark plug. It has been found that in particular the ground electrode of conventional spark plugs or prechamber spark plugs in conjunction with a high prechamber volume tends to overheating. Furthermore, the prechamber volume of one-piece prechamber spark plugs is restricted both thermally and also by the combustion chamber in the cylinder head. In conventional spark plugs and conventional prechamber spark plugs, the ground electrode is a fixed component of the spark plug or prechamber spark plug, so that the conventional prechamber spark plug or spark plug is an indivisible structural unit comprising the ignition electrode, for example formed as a central electrode, and the ground electrode.

As a result of the structural separation of the spark plug and the ground electrode provided according to the disclosure, excessively high heating of the ground electrode can be avoided. In this way, undesired pre-ignition and glow ignition can be avoided, so that effective and efficient operation of the internal combustion engine can be ensured. In particular, as a result of the structural separation of the spark plug from the ground electrode or vice versa, it is possible to design the ground electrode to be particularly solid and thus to be equipped with a particularly high mass, so that the ground electrode can have a higher thermal capacity as compared with conventional solutions. As compared with conventional solutions, this reduces the maximum temperature of the ground electrode during a combustion cycle. On the other hand, for example, a particularly advantageous large-area attachment of the ground electrode to the third component, in particular to the cylinder head, can be made, which permits improved thermal conduction as compared with conventional solutions. This means that, in comparison with conventional solutions, heat can pass and be dissipated better from the ground electrode to the third component, so that excessively high temperatures of the ground electrode can be avoided.

In order to be able to avoid undesired ignition and combustion and thus to be able to ensure particularly advantageous operation of the internal combustion engine, in one embodiment, provision is made for the prechamber ignition means to have a housing element formed separately from the spark plug and separately from the ground electrode and optionally also separately from the third component, in which the spark plug is at least partly accommodated, i.e. arranged, in particular at least predominantly and thus at least by more than half.

It has been shown to be particularly advantageous if the ground electrode is supported directly on the housing element and thus in particular rests directly on the housing, as a result of which heat from the ground electrode can be dissipated particularly advantageously. Apart from the direct support of the ground electrode on the housing element, a direct connection between the ground electrode and the housing element is omitted, so that the ground electrode is not connected directly to the housing element. As a result, for example, particularly advantageous, in particular structural, separation of the spark plug from the ground electrode or vice versa can be implemented, so that excessively high temperatures of the ground electrode can advantageously be avoided.

In order on the one hand to form the spark plug and the ground electrode advantageously as structurally separated components and, on the other hand, to be able to implement simple and thus time-saving and inexpensive production of the internal combustion engine, in a further configuration, provision is made for the ground electrode to be connected directly to the housing element. In the completely produced state of the internal combustion engine, for example the housing element is mounted, in particular directly, on the third component, in particular in such a way that relative movements between the housing element and the third component are suppressed. For example, the housing element is connected directly to the third component, in particular such that the housing element is screwed directly to the third structural element. Since, for example, provision is made for the ground electrode to be connected directly to the housing element, for example assembly of the housing element on the third component is associated with mounting the ground electrode on the third component or vice versa, so that the internal combustion engine can be produced in a time-saving and inexpensive manner. In addition, in this way heat can particularly advantageously pass from the ground electrode to the housing element, for example from the latter to the third component, so that excessively high temperatures of the ground electrode can be avoided.

It has proven to be particularly advantageous if the ground electrode is welded directly to the housing element, in particular by frictional welding, and is connected as a result. In this way, heat can particularly advantageously pass from the ground electrode to the housing element and thus be transported away from the ground electrode, so that excessively high temperatures of the ground electrode and thus undesired, unfavorable combustion and ignition of the mixture can be avoided.

In at least some embodiments, the spark plug is screwed directly to the housing element and, as a result, connected directly to the housing element. The spark plug can be nondestructively and detachably screwed and thus connected to the housing element. As a result, simple advantageous production of the internal combustion engine can be implemented, wherein, at the same time, structural separation between the spark plug and the ground electrode can advantageously be ensured.

For example, the spark plug, in particular a housing of the spark plug, has a first thread, in particular in the form of a first external thread. For example, the housing element has a second thread corresponding to the first thread, in particular in the form of a first internal thread. Provision can be made for the first thread and the second thread to be screwed directly to each other, in particularly in such a way that the first external thread is screwed directly into the first internal thread.

A further embodiment is distinguished by the fact that the prechamber ignition means has the cylinder head for the internal combustion engine, which is formed separately from the spark plug, separately from the ground electrode and separately from the housing element. The housing element, the spark plug and the ground electrode are each at least partly arranged in the cylinder head. For example, the ground electrode and/or the housing element are arranged completely in the cylinder head. In this way, heat can particularly advantageously pass from the ground electrode directly to the cylinder head and/or via the housing element to the cylinder head, so that excessively high temperatures and thus unfavorable combustion and ignition of the mixture can be avoided.

It has been shown to be particularly advantageous if the housing element is screwed directly to the cylinder head and, as a result, is connected directly to the cylinder head. In particular, the housing element is nondestructively detachably screwed to the cylinder head. Firstly, in this way the internal combustion engine can be produced in a particularly time-saving and inexpensive manner. Secondly, in this way heat can particularly advantageously pass from the housing element to the cylinder head and thus be transported away from the ground electrode, so that excessively high temperatures of the ground electrode can advantageously be avoided.

For example, the housing element has a third thread, in particular in the form of a second external thread, wherein, for example, the cylinder head has a fourth thread corresponding to the third thread, in particular in the form of a second internal thread. For example, the third thread and the fourth thread are screwed directly to each other, as a result of which the housing element is screwed directly to the cylinder head. For example, the second external thread is screwed directly into the second internal thread.

Provision can be made that, in particular with the between the ground electrode and the cylinder head and/or with the exception of at least or exactly one electrically conductive connection between the ground electrode and the cylinder head, a direct connection between the ground electrode and the cylinder head is omitted. In this way, a particularly advantageous structural separation between the spark plug and the ground electrode can be ensured, so that excessively high temperatures of the ground electrode can be avoided.

It has been shown to be particularly advantageous if the ground electrode is screwed directly to the cylinder head. In this way, heat can particularly advantageously pass from the ground electrode directly to the cylinder head, as a result of which excessively high temperatures of the ground electrode can reliably be avoided. For example, the third thread, in particular formed as an external thread, extends, in particular continuously, over the housing element and the ground electrode, in particular over a first external circumferential lateral surface of the housing element and a second external circumferential lateral surface of the ground electrode, So that, advantageously, both the housing element and the ground electrode are screwed directly to the fourth thread directly to the cylinder head-by means of the third thread. As result, particularly advantageous, mechanical and in particular thermal attachment both of the housing element and of the ground electrode to the cylinder head can be implemented, as a result of which heat can particularly advantageously pass from the ground electrode to the cylinder head and directly to the housing element and via the housing element to the cylinder head. As a result, excessively high temperatures of the ground electrode can advantageously be avoided.

In order to be able to implement particularly advantageous combustion, in a further embodiment, provision is made for a first part of the prechamber to be delimited, in particular directly, by a first housing part formed separately from the spark plug, separately from the ground electrode and separately from the housing element and advantageously also separately from the third component. For example, a first subregion of the first housing part is arranged in the third component, for example a second subregion of the first housing part projects into the main combustion chamber. For example, the overflow openings, in particular all the overflow openings, are in particularly respectively completely formed in the first housing part, so that, for example, the respective overflow opening is formed as a respective passage opening penetrating the first housing part, in particular completely, which is also designated as passage flow opening. A second part of the prechamber is delimited, in particular directly, by a second housing part formed separately from the spark plug, separately from the ground electrode, separately from the housing element and separately from the first housing part and advantageously also separately from the third component, wherein the second part can be larger than the first part. In this way, a particularly large volume of the prechamber can be ensured in a particularly advantageous way, and unfavorable combustion and ignition can advantageously be avoided.

It has been shown to be particularly advantageous if the housing parts are formed separately from the cylinder head. As a result, particularly advantageous thermal relationships can be created, so that excessively hot parts and thus unfavorable, undesired combustion and ignition can be avoided.

For example, the second housing part is arranged, in particular completely, in the cylinder head, wherein, for example, the second housing part can be arranged, in particular completely, outside the combustion chamber.

In some embodiments, the first housing part is formed from a first material, the second housing part being formed from a second material that is different from the first material. In some embodiments, the first material is a metallic material. Alternatively or additionally, the second material can be a metallic material. In this way, particularly advantageous thermal conditions can be created, so that excessively hot points and thus undesired ignition and combustion can be avoided.

The first material is in some embodiments a nickel-based alloy, wherein advantageously the first material can be Inconel®. Advantageously, the second material is copper or a copper alloy. In particular, for example, the second material is a copper-zirconium alloy. As a result, particularly advantageous thermal conditions can be created.

Finally, it has been shown to be particularly advantageous if at least one third part of the prechamber, formed as a residual gas chamber, is delimited, in particular directly, by the housing element. In some embodiments, the third part is smaller than the second part and smaller than the first part. In order to be able to implement particularly advantageous thermal conditions as a result and, very particularly, avoid excessively high temperatures of the ground electrode, in a further embodiment, provision is made for at least a fourth part of the prechamber to be arranged in a passage opening in the ground electrode and, as a result, to be delimited, in particular directly, by the ground electrode, wherein the passage opening in the ground electrode opens directly into the second part at one end and directly into the third part at the other end. In some embodiments, the fourth part is smaller than the third part and smaller than the second part and smaller than the first part.

In order to be able to particularly advantageously avoid excessively high temperatures of the ground electrode, in a further embodiment, provision is made for the ground electrode to be disk-shaped, i.e. formed as a disk. In this case, the ground electrode is, for example, designed to be cylindrical on the external circumference.

A further embodiment is distinguished by the fact that the ground electrode has an engagement opening formed as a passage opening, which in particular is provided in addition to the passage opening in which the fourth part is arranged, wherein the ignition electrode, for example formed as a central electrode, engages in the engagement opening. As a result, for example, the ground electrode can particularly advantageously be provided with a high mass in order to be able to advantageously avoid excessively high temperatures of the ground electrode.

Finally, it has been shown to be particularly advantageous if the ground electrode is sealed off with respect to the second housing part by means of at least one sealing device. For example the sealing device is or comprises at least or exactly one sealing element in particular formed separately from the ground electrode and separately from the second housing part and advantageously also separately from the first housing part and separately from the housing element, by means of which the ground electrode is sealed off with respect to the second housing part. For example, the sealing device, in particular the sealing element, rests on the ground electrode on one side and on the second housing part on the other side, in particular directly in each case. The sealing device, in particular the sealing element, can be formed as a solid body wherein, for example, the sealing device, in particular the sealing element, can be formed from a metallic material such as, for example, copper. Furthermore, it would be conceivable for the sealing device, in particular the sealing element, to be formed as a liquid seal. By means of the sealing element, advantageous sealing of the prechamber can be implemented, so that particularly advantageous efficient operation is feasible.

A second aspect relates to an internal combustion engine, also designated as an internal combustion motor or motor and for example, as a reciprocating piston motor, i.e. a reciprocating piston engine, which has at least one prechamber ignition means according to the first aspect. Advantages and advantageous embodiments of the first aspect discussed above are to be viewed as advantages and advantageous embodiments of the second aspect and vice versa. Advantageously, the internal combustion engine has at least one or more combustion chambers, wherein the respective combustion chamber is assigned in particular exactly one prechamber ignition means according to the disclosure according to the first aspect.

The above-described features and embodiments, as well as others, will become more readily apparent to those of ordinary skill in the art by reference to the following detailed description and accompanying drawings.

### BRIEF DESCRIPTION OF THE DRAWINGS

FIG. 1 shows as a detail a schematic sectional view of an internal combustion engine for a motor vehicle, with a prechamber ignition means;

FIG. 2 shows as a detail a schematic and sectioned exploded view of the prechamber ignition means; and

FIG. 3 shows as a detail a further schematic sectional view of the internal combustion engine.

### DETAILED DESCRIPTION

In the figures, identical or functionally identical elements are provided with the same designations.

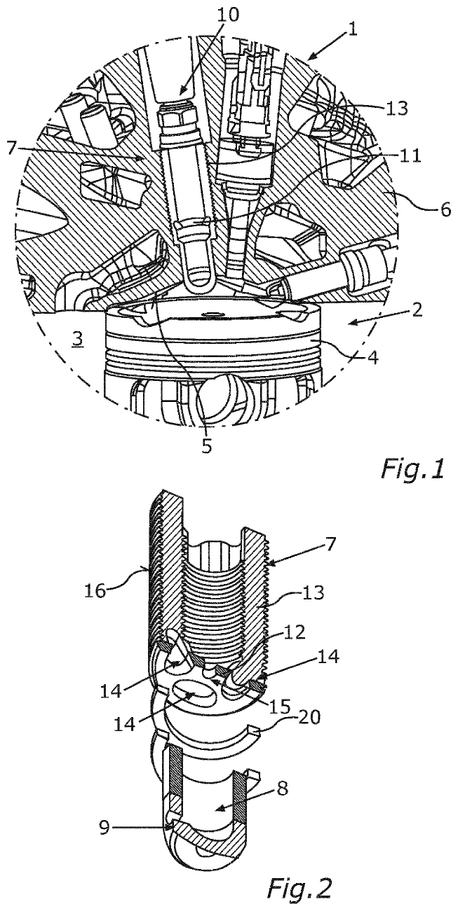

FIG. 1 shows, as a detail in a schematic sectional view, an internal combustion engine 1, also designated as a motor or internal combustion motor and formed as a reciprocating piston motor, consequently as a reciprocating piston engine, for a motor vehicle also simply designated as a vehicle. This means that in its completely produced state, the motor vehicle has the internal combustion engine 1 and can be driven by means of the internal combustion engine 1. The internal combustion engine 1 has at least one combustion chamber 2, which is delimited partly by a cylinder 3, partly by a piston 4 and partly by a combustion chamber roof 5. The cylinder 3 is formed as a cylinder housing of the internal combustion engine 1, for example formed as a cylinder crankcase. The piston 4 is translationally movable in the cylinder 3 and thus translationally movable relative to the cylinder housing between an upper dead center and a lower dead center. The combustion chamber roof 5 is formed by a cylinder head 6 of the internal combustion engine 1, the cylinder head 6 being formed separately from the cylinder housing and connected to the cylinder housing.

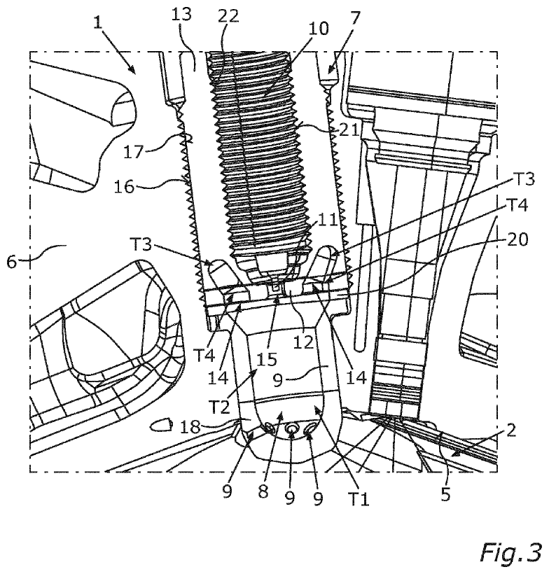

The internal combustion engine 1 has a prechamber ignition means 7 which, for example, can comprise the cylinder head 6. FIG. 2 shows the prechamber ignition means 7, which is designated simply as a prechamber system or prechamber device, as a detail in a schematic, sectioned and perspective exploded view. The prechamber ignition means 7 has a prechamber 8, which can be seen particularly well from FIG. 3, and a plurality of overflow openings 9 formed as passage openings, via which the prechamber 8 is fluidically connected to the combustion chamber 2 of the internal combustion engine 1, also designated as the main combustion chamber. The prechamber 8 is fluidically connected to the combustion chamber 2 via the overflow openings 9 and is otherwise completely fluidically separated from the combustion chamber 2. Via the overflow openings 9, a fuel-air mixture, simply also designated as a mixture and comprising a preferably liquid fuel and air, can be introduced into the prechamber 8 from the combustion chamber 2.

It can be seen particularly well from a combined view of FIGS. 1 and 3 that the prechamber ignition means 7 has a spark plug 10, which has an ignition electrode 11, for example formed as a central electrode. By means of the ignition electrode 11, in particular within a respective working cycle of the internal combustion engine 1, at least one ignition spark can be produced in the prechamber 8, between the ignition electrode 11 and a corresponding ground electrode 12. In particular, within the respective working cycle of the internal combustion engine 1, a first part of the mixture flows out of the main combustion chamber into the prechamber 8 via the overflow openings 9 and, for example, a second part of the mixture remains in the main combustion chamber (combustion chamber 2). By means of the ignition spark, within the respective working cycle the part of the mixture that has flowed into the prechamber 8 can be ignited and burned as a result. The ignited and as a result burned or burning mixture flows through the overflow openings 9 and thus out of the prechamber 8 via the overflow openings 9 and into the main combustion chamber (combustion chamber 2), in which the burning first part of the mixture ignites the second part of the mixture and burns it as a result. In this way, for example, the piston 4 is driven.

In order then to avoid excessively high temperatures of the ground electrode 12 and thus undesired, unfavorable ignition and combustion of the mixture, the ground electrode 12 and the spark plug 10 having the ignition electrode 11 are formed as structurally separated components. The spark plug 10 is intrinsically, i.e. considered on its own, free of a dedicated ground electrode corresponding to the ignition electrode 11.

The prechamber ignition means 7 has a housing element 13 formed separately from the spark plug 10, separately from the ground electrode 12 and separately from the cylinder head 6 which, as will be explained in more detail below, is formed or functions as an adapter bush. In the exemplary embodiment shown in the figure, the ground electrode 12 is formed as a disk, which is cylindrical on the outer circumference and is thus circular. As will be explained in more detail below, the ground electrode 12 has a plurality and thus at least or exactly two passage openings 14, which penetrate the ground electrode 12 completely. In addition, the ground electrode 12 has an engagement opening 15 provided in addition to the passage openings 14 and formed as a further passage opening, which penetrates the ground electrode 12 completely. The ignition electrode 11 engages in the in particular central engagement opening 15 in the ground electrode 10. In the exemplary embodiment shown in the figure, the housing element 13 is at least partly arranged in the cylinder head 6, and the ground electrode 12 is arranged completely in the cylinder head 6. The spark plug 10 is arranged at least partly in the cylinder head 6 and at least partly in the housing element 13. In the exemplary embodiment shown in the figure, the ground electrode 12 is connected directly to the housing element 13, for example in such a way that the ground electrode 12 is welded directly to the housing element 13 by friction welding and connected as a result. Alternatively, it would be conceivable for the ground electrode 12 to be supported directly on the housing element 13, wherein, apart from this direct support of the ground electrode 12 on the housing element 13, a direct connection between the ground electrode 12 and the housing element 13 is not provided, i.e. is omitted.

In the exemplary embodiment shown in the figure, the spark plug 10 is screwed directly to the housing element 13. For this purpose, the spark plug 10 has a first thread 21 in the form of a first external thread, and the housing element 13 has a second thread 22 corresponding to the first thread 21 in the form of a first internal thread. The first external thread is screwed directly into the first internal thread. In the exemplary embodiment shown in the figure, the housing element 13 and the ground electrode 12 form a third thread 16 in the form of a second external thread, so that, so to speak, the third thread 16 extends in particular continuously over at least part of the housing element 13 and at least over part of the ground electrode 12, consequently is formed at least in a subregion of the housing element 13 and at least a subregion of the ground electrode 12. Expressed once more in other words, the housing element 13 has a first threaded part of the thread 16, and the ground electrode 12 has a second threaded part of the thread 16, in particular the threaded parts merging directly and preferably flush into one another. The cylinder head 6, formed separately from the housing element 13 and separate from the ground electrode 12, has a fourth thread 17 corresponding to the third thread 16 in the form of a second internal thread, wherein the third thread 16 and the fourth thread 17 are screwed directly to each other, in particular in such a way that the second external thread is screwed directly into the second internal thread. As a result, both the housing element 13 and the ground electrode 12 are each screwed directly to the cylinder head 6, in particular each screwed directly into the cylinder head 6. In addition, it can be seen from the figure that, for example, the spark plug 10 can be detached from the housing element 13 and from the cylinder head 6 and thus disassembled, in particular unscrewed, while the housing element 13 and the ground electrode 12 are screwed to the cylinder head 6 and thus mounted on the cylinder head 6, consequently remain fixed. As a result of this structural separation between the spark plug 10, on the one hand, and the ground electrode 12, on the other hand, an excessively high temperature of the ground electrode 12 can be avoided.

In the exemplary embodiment shown in the figure, a first part T1 of the prechamber 8 is delimited by a first housing part 18, in particular directly. A second part T2 of the prechamber 8, in particular larger than the first part T1, is delimited by a second housing part 19, in particular directly, wherein the housing parts 18 and 19 are preferably formed separately from one another and connected to one another, in particular directly. For example, the housing parts 18 and 19 are welded directly to one another, in particular by friction welding, and connected directly to one another as a result. Very preferably, the housing part 18 is formed from an in particular metallic first material, and the housing part 19 is, for example, formed from a second, in particular metallic, material that is different from the first material. For example, the first material is a nickel-based alloy and, for example, Inconel®, wherein, for example, the second material is a copper alloy, in particular a copper-zirconium alloy. The housing element 13 is, for example, formed from a third material which, for example, is a material that is different from the first material. For example, the third material corresponds to the second material or the third material is a material that is different from the second material. The cylinder head 6 is, for example, formed from a fourth material. Preferably, the fourth material is a metallic material. Preferably, the third material is a metallic material. Preferably, the fourth material is a material that is different from the third material and/or from the second material and/or from the first material. Very particularly, the fourth material is aluminum or an aluminum alloy. Preferably, the third material has first thermal expansion coefficient, for example, the fourth material having a second thermal expansion coefficient. Preferably, a difference between the first thermal expansion coefficient and the second thermal expansion coefficient is at most 6, in particular at most 5 and very particularly at most 4. For example, the thermal expansion coefficient of the fourth material is wherein, for example, the thermal expansion coefficient of the third material 17 is. As a result excessive thermally induced relative movements and thus stresses between the housing element 13 and the cylinder head 6 can be avoided.

Since the housing parts 18 and 19 are connected to one another, in particular directly, the housing parts 18 and 19 form a lower housing part, also designated simply as a lower part. Preferably, if the lower housing part and the cylinder head 6 are considered in isolation i.e. on their own, the lower housing part is connected to the cylinder head 6, in particular directly, in particular in such a way that the housing part is pressed together with the cylinder head 6, in particular pressed into the cylinder head 6. It can be seen from FIG. 3 that the housing part 19 is arranged completely in the cylinder head 6. A first part of the housing part 18 is arranged in the cylinder head 6, and a second part of the housing part 18 is arranged outside the cylinder head 6 and projects into the main combustion chamber. The overflow openings 9, in particular all the overflow openings 9, are arranged in the second part of the housing part 18. In particular, it can be seen that the overflow openings 9, in particular all the overflow openings 9, are formed in the housing part 18.

The prechamber ignition means 7 further comprises a sealing device designated as a sealing element 20, wherein the sealing element 20 is formed separately from the housing parts 18 and 19, separately from the ground electrode 12, separately from the cylinder head 6 and separately from the housing element 13 and also separately from the spark plug 10. The sealing element 20 in the present case is arranged between the ground electrode 12 and the lower housing part, in particular the housing part 19, in particular in such a way that the sealing element 20 is supported, in particular directly, on the ground electrode 12 at one end and is supported, in particular directly, and thus rests on the housing part 19 at the other end. In the present case, the sealing element 20 is formed as a sealing ring. By means of the sealing element 20, the ground electrode 20 is sealed off with respect to the second housing part 19.

The fact that the lower housing part is pressed together with the cylinder head 6 means that there is a particularly advantageous transfer of heat between the lower housing part and the cylinder head 6, so that excessively high temperatures can be avoided. In particular, it is conceivable that the housing part 19 and/or the housing part 18 is pressed together with the cylinder head 6, in particular directly in each case. For example, the sealing element 20 is formed from a metallic material such as, for example, copper. For example, with the exception of the fact that the sealing element 20, for example formed as a sealing ring, is supported, in particular directly, on the ground electrode 12 and in particular directly on the housing part 19, a direct connection between the sealing element 20 and the ground electrode 12 and between the sealing element 20 and the housing part 19 is not provided, i.e. not formed, so that with the exception of the fact that the sealing element 20 rests, in particular directly, on the ground electrode 12 and on the housing part 19, the sealing element 20 is not connected to the ground electrode 12 and not to the housing part 19.

It can be seen particularly well from FIGS. 1 and 3 that at least or exactly two third parts T3 of the prechamber 8, formed as a residual gas chamber, are delimited, in particular directly, by the housing element 13. For example, respective volumes of the residual gas chambers in total represent at least 30% of the total volume of the prechamber 8. For each third part T3, a respective, fourth part T4 of the prechamber 8 is arranged in the respective passage opening 14 of the ground electrode 12, so that a number of the residual gas chambers corresponds to a number of the fourth parts T4 or the passage openings 14. Thus, the respective fourth parts T4 are formed, in particular directly, by the ground electrode 12. The passage openings 14 of the ground electrode 12 open directly into the third part T3 at one end and directly into the second part T2 at the other end. In this way, which is beneficial to installation space, a particularly large volume of the prechamber 8 can be implemented, the volume of which represents, for example, exactly or at least 1000 mm³.

Since the third material and the fourth material have the same or similar thermal expansion coefficients, heat can particularly easily pass from the housing element 13 to the cylinder head 6. In addition, heat can particularly easily pass from the ground electrode 12 to the housing element 13 and directly to the cylinder head 6 so that advantageous transport of heat away from the ground electrode 12 can be implemented. As a result, excessive temperatures of the ground electrode 12 can be avoided. It can also be seen that the spark plug 10 is mounted and held on the cylinder head 6 with the interposition of the housing element 13, so that the housing element 13 is formed or functions as an adapter sleeve or adapter bush.

The respective residual gas chamber is or comprises a respective residual gas volume, in which residual gas can be accommodated. The residual gas volume can be configured to be particularly large.

By means of the ignition electrode 11, the ignition spark between the ignition electrode 11 and the ground electrode 12 can be produced at an ignition location also designated as an ignition point, wherein the respective residual gas chamber, consequently the respective residual gas volume, is arranged on a side of the ignition location facing away from the main combustion chamber and thus above the ignition location. Such an arrangement of the respective residual gas volume above the ignition location contributes to particularly advantageous mixture formation at the ignition location, since the residual gas that is always present is concentrated here.

For example, it can be seen from FIG. 2 that the number of residual gas chambers and thus the number of passage openings 14 is four so that, for example, the ground electrode 12 has a total of exactly five passage openings, namely the passage openings 14 and the engagement opening 15. However, this is only an example in the present case, although advantageous.

### LIST OF DESIGNATIONS

1 Internal combustion engine
2 Combustion chamber
3 Cylinder
4 Piston
5 Combustion chamber roof
6 Cylinder head
7 Prechamber ignition means
8 Prechamber
9 Overflow opening
10 Spark plug
11 Ignition electrode
12 Ground electrode
13 Housing element
14 Passage opening
15 Engagement opening
16 Third thread
17 Fourth thread
18 First housing part
19 Second housing part
20 Sealing element
21 First thread
22 Second thread
T1 First part
T2 Second part
T3 Third part
T4 Fourth part

1.-15. (canceled)

16. A prechamber ignition apparatus for an internal combustion engine, comprising:
a prechamber having a plurality of overflow openings via which the prechamber can be fluidically connected to a combustion chamber of the internal combustion engine and at least part of a mixture comprising fuel and air can be introduced into the prechamber from the combustion chamber; and
a spark plug which has an ignition electrode, by which at least one ignition spark can be produced in the prechamber between the ignition electrode and a corresponding ground electrode in order to ignite a part which is introduced into the prechamber via the overflow openings,
wherein
the ground electrode and the spark plug having the ignition electrode are formed as structurally separated components.

17. The prechamber ignition apparatus as claimed in claim 16, further comprising:
a housing element formed separately from the spark plug and separately from the ground electrode, in which the spark plug is at least partly accommodated.

18. The prechamber ignition apparatus as claimed in claim 17, wherein:
the ground electrode is supported directly on the housing element; and
apart from direct support of the ground electrode on the housing element, a direct connection between the ground electrode and the housing element is omitted.

19. The prechamber ignition apparatus as claimed in claim 17, wherein:
the ground electrode is connected directly to the housing element.

20. The prechamber ignition apparatus as claimed in claim 19, wherein:
the ground electrode is welded directly to the housing element.

21. The prechamber ignition apparatus as claimed in claim 20, wherein:
the spark plug is screwed directly to the housing element.

22. The prechamber ignition apparatus as claimed in claim 17, wherein:
the spark plug is screwed directly to the housing element.

23. The prechamber ignition apparatus as claimed in claim 17, further comprising:
a cylinder head for the internal combustion engine, which is formed separately from the spark plug, separately from the ground electrode and separately from the housing element, wherein the housing element, the spark plug and the ground electrode are each at least partly arranged in the cylinder head.

24. The prechamber ignition apparatus as claimed in claim 23, wherein:
the housing element is screwed directly to the cylinder head.

25. The prechamber ignition apparatus as claimed in claim 23, wherein:
the ground electrode is screwed directly to the cylinder head.

26. The prechamber ignition apparatus as claimed in claim 23, wherein:
a first part of the prechamber is delimited by a first housing part formed separately from the spark plug, separately from the ground electrode and separately from the housing element; and
a second part of the prechamber is delimited by a second housing part formed separately from the spark plug, separately from the ground electrode, separately from the housing element and separately from the first housing part.

27. The prechamber ignition apparatus as claimed in claim 26, wherein:
the first housing part and the second housing part are formed separately from the cylinder head.

28. The prechamber ignition apparatus as claimed in claim 26, wherein:
the first housing part is formed from a first material and the second housing part is formed from a second material that is different from the first material.

29. The prechamber ignition apparatus as claimed in claim 26, wherein:
at least a third part of the prechamber, formed as a residual gas chamber, and is delimited by the housing element; and
at least a fourth part of the prechamber is arranged in a passage opening of the ground electrode and is delimited by the ground electrode,
the passage opening of the fourth part opens directly into the second part at one end and directly into the third part at another end.

30. The prechamber ignition apparatus as claimed in claim 26, wherein:
the ground electrode is sealed off with respect to the second housing part using at least one sealing device.

31. The prechamber ignition apparatus as claimed in claim 17, wherein:
a first part of the prechamber is delimited by a first housing part formed separately from the spark plug, separately from the ground electrode and separately from the housing element; and
a second part of the prechamber is delimited by a second housing part formed separately from the spark plug, separately from the ground electrode, separately from the housing element and separately from the first housing part.

32. An internal combustion engine having at least one pre-chamber ignition apparatus as claimed in claim 17.

33. An internal combustion engine having at least one pre-chamber ignition apparatus as claimed in claim 16.
